(19) United States
(12) Patent Application Publication
(10) Pub. No.: US 2017/0116432 A1
(43) Pub. Date: Apr. 27, 2017

(54) SYSTEM AND METHODS FOR CYBER-AND-PHYSICALLY-SECURE HIGH GRADE WEAPONRY

(71) Applicant: Daniel Minoli, Red Bank, NJ (US)

(72) Inventor: Daniel Minoli, Red Bank, NJ (US)

(21) Appl. No.: 15/004,056

(22) Filed: Jan. 22, 2016

Related U.S. Application Data
(60) Provisional application No. 62/125,409, filed on Jan. 22, 2015.

(51) Int. Cl. G06F 21/62; G06F 17/30

(52) U.S. Cl. CPC G06F 21/6218; G06F 17/30312

(57) ABSTRACT

System and Methods for Cyber-And-Physically Secure High-Grade Weaponry are described. An exemplary system may involve a computing device embedded in a high grade instrument such that the computing device is communicatively coupled to at least one apparatus. The system further includes a memory arrangement having stored thereon instructions that upon execution by the at least one computing device, cause the at least one computing device to execute in a sequence specific to the high grade instrument, one or more applications associated with the high grade instrument. As a result, the operation of the high grade instrument is remotely enabled and its configuration locally controlled.

### CROSS REFERENCE TO RELATED APPLICATIONS

This application claims the benefit to U.S. Provisional Application No. 62/125,409, filed on Jan. 22, 2015, which application is incorporated herein by reference as if set forth in its entirety.

### FIELD OF THE INVENTION

The present invention relates generally to the field of remotely controlled equipment, and more particularly to a remote controlled field-deployed high-grade weaponry.

### BACKGROUND OF THE INVENTION

This invention addresses the issue of U.S.-taxpayer-paid weapons being misused by mercenaries and inimical agents. While the technologies disclosed in “gun safety” prior art enable the local/proximity control of a small-form-factor weapon, the present invention enables telecommunications/cyber-related remote control of large-form-factor smart weapon.

Vehicles tracking transponder system and transponding methods (for example, U.S. Pat. No. 5,917,423) have been used by companies such as Lojack Corporation to locate stolen vehicles. Lojack owns a number of patents related to locating and/or disabling stolen cars, including U.S. Pat. Nos. 5,917,423, 6,229,988, 6,522,698, 6,665,613, 6,876,858, 6,847,825, 7,536,169, 8,086,215, 7,973,649, 7,561,102, 7,593,711, 7,853,218, 7,511,606, 6,498,565, 7,091,835, 5,895,436, 8,787,823, 7,664,462, 8,149,142, 8,013,735, 8,169,328, 8,618,957, 8,339,220, 8,242,810, 8,630,605, 8,229,518, 8,130,050, 8,169,279, 8,350,695.

Moreover, as disclosed in M. Greene, “A Review of Gun Safety Technologies” U.S. Department of Justice, Office of Justice Programs, National Institute of Justice, Research Report, June 2013. Also www.nij.gov, Technologies that are outlined here have been integrated into the various firearms described in this report to enable authorization of the user. An authorization system generally combines an authentication mechanism which actuates a blocking mechanism in a seamless process designed to take less time than handling and firing a conventional gun. The authentication mechanisms use radio frequency identification, biometrics such as fingerprints, or some other technology that can be used to establish a unique identity. This unique identity in general is not required to be something intrinsic to a user, such as a fingerprint, but could be a unique code broadcast at very short distances by an RFID token worn as a ring or watch by the operator. Once a user is identified and authenticated, authorization systems will typically energize an electronic circuit that produces a physical change such as removing a mechanical block to allow the gun to fire. Blocking mechanisms that have been employed include solenoids, motors, and piezoelectric devices which can be used as actuators that respond to signals from the authentication mechanism.

### Token-Based Technologies

Token-based technologies require the use of an additional physical item—such as a ring, watch, card, or bracelet—to allow for the operation of the system. These tokens may be carried by, worn by, or even implanted into an authorized user. In general, an external token requires that the user remember to have it on their person and is susceptible to theft by unauthorized individuals. Stolen token devices can then be used to authorize their associated firearm However, additional security measures built into the token device, such as a token device with a personal identification number (PIN) code, may mitigate use by unintended users.

### Radio Frequency Identification (RFID) Technologies.

RFID is the wireless use of radio frequency electromagnetic fields to transfer data for the purposes of automatically identifying and tracking tags attached to objects. Some tags require no battery and are powered at short ranges by electromagnetic induction. These are called passive tags. Others use a local power source and emit radio waves. These are called active tags. The tag contains electronically stored information which may be read from up to several meters away. Unlike a bar code, the tag does not need to be within line of sight of the reader and may be embedded in the tracked object. In the context of this report, RFID-based token technologies establish a communication channel between the firearm and the token. Typically, the RFID reader on the firearm broadcasts a signal looking for a token, then a coded signal is sent from the token to the firearm which will authorize the gun to be fired. This technology works while wearing gloves and can be implanted subdermally, as was recommended in the 2005 NAE report. It should be noted that any RF technology could be impacted by interference, but it would depend on a number of factors such as operating frequency and operating range. Uses at the ranges described here are less susceptible to interference due to the very short operating distances.

### Ultrasonic Technologies.

In the one case of an ultrasonic based token, the token is worn on the body of the user and emits an ultrasonic coded signal that is received by the firearm or vice versa. The frequency of the sound is too high for humans to hear, and can be used for determining proximity of the gun. If the gun is not within a specified range, it automatically deactivates. This technological approach has not been widely adopted.

### Magnetic Technologies.

In the one case of a magnetic token, a permanent magnet is simply used to magnetically move a blocking mechanism located in the interior of the firearm. This technological approach has not been widely adopted.

### Biometric Technologies

Biometric technologies utilize unique features of individuals as the “key” to identify authorized users. Some examples of biometric technologies include fingerprint, palm print, voice, face, and vein pattern, although not all of these are used for firearm authorization. Appropriate electronic sensors or readers are used to collect the biometric and compare it to those of authorized users stored in computer memory.

### Fingerprint Technologies.

To initiate authorization, the user places their finger on a fingerprint sensor. The reader is typically placed in an area that is easily and normally accessible with little or no conscious effort by the user, such as on the grip of where the finger normally rests. Once the fingerprint is scanned, it is quickly compared to an internally stored list of fingerprints of authorized users. If a match is found, the firearm is enabled; otherwise, it remains in the locked state.

### Palm Print Technologies.

Palm print technologies work like fingerprint technologies and use the palm print as the unique identifier. No evidence was uncovered in compiling this report that demonstrates that palm print technology has ever been successfully integrated into a firearm authorization system.

Dynamic Grip Technologies. Dynamic grip recognition (DGR) is an emerging biometric authentication method based on the human grasping behavior. A dynamic biometric is a combination of physical and behavioral characteristics that is measured over a duration of time versus a point in time. It is not based on an inherent physical trait of an individual, such as a fingerprint, but rather that grasping behaviors can be used as an identifiable activity. Examples of attributes that could be measured as part of DGR include hand size, hand geometry, and the pressure or strength a hand places on an item at various points. Research on DGR remains ongoing and no evidence was uncovered to suggest that this approach has been validated or widely accepted yet by the biometrics community of practice.

### Static Grip Technologies.

Static grip recognition (SGR) is an emerging biometric authentication method based on the human grasping behavior at a fixed moment in time. It is similar to DGR, described above, but does not involve measurements of user action or data over time. Instead SGR simply measures the pressure applied by holding the firearm. Research on SGR remains ongoing and no evidence was uncovered to suggest that this approach has been validated or widely accepted yet by the biometrics community of practice.

### Optical Technologies.

Authorization techniques that utilize optical methods for identification may rely on spectroscopic data, such as slight variances in skin color, or image data, such as vein pattern recognition in the palm of the hand. These typically operate in the visible or near-infrared regions. Previously collected optical data of a certified user would be compared to the data collected from a potential user to decide whether to authorize the user. This technological approach has not been widely adopted.

### SUMMARY OF THE INVENTION

Various embodiments provide a system and methods for cyber and physically secure high grade weaponry. Recent advances in satellite communication, including High Throughput Satellites (HTS), and Machine to Machine (M2M) and Internet of Things (IoT), which aim at injecting smart control capabilities in all sorts of “things”, can come to the aid of the question: “How does one control sophisticated weapons given to partners-de-jour, which weapons are then ‘flipped’ or stolen (by bands or politically-reversed states, e.g., after a coup.) This invention squarely addresses this chronic and extant issue by embedding its cyber-logic into all manufactured high-grade weaponry and requiring a constant keep-alive signal from a satellite or other terrestrial broadcasting system in order for the weapon to remain operative. This cyber-logic is embedded in a tamper-proof micro-enclosure, which if interfered with in any way, will permanently incapacitate the weapon.

In one embodiment, a system for remotely controlling a high grade weaponry is provided. The system comprises at least one computing device embedded in a high grade instrument wherein said at least one computing device is communicatively coupled to at least one apparatus; a memory arrangement having stored thereon instructions that upon execution by the at least one computing device, cause the at least one computing device to execute in a sequence specific to the high grade instrument, one or more applications associated with the high grade instrument, to propagate signaling information towards the at least one apparatus, thereby enabling said at least one apparatus to interact with the at least one computing device and exchange a plurality of data points with the at least one computing device for use in updating the one or more corresponding applications, wherein the operation of the high grade instrument is remotely enabled and its configuration locally controlled.

Another embodiment is directed to a method for remotely controlling a high grade weaponry. The method includes a computing device receiving a plurality of data points corresponding to a specific high grade instrument; the computing device embedded in a high grade instrument wherein said at least one computing device is communicatively coupled to at least one apparatus, the computing device determines one or more subset of data points indicative of the identity of said specific high grade instrument; based on an output of a comparison of the one or more predefined identification data with the subset of data points, execute in a sequence specific to the high grade instrument, one or more applications associated with the high grade instrument, to propagate signaling information towards the at least one apparatus, thereby enabling said at least one apparatus to interact with the at least one computing device and exchange a plurality of data points with the at least one computing device for use in updating the one or more corresponding applications, wherein the operation of the high grade instrument is remotely enabled and its configuration locally controlled.

Yet another embodiment provides a non-transitory computer readable medium. The non-transitory computer readable medium has stored thereon instructions that, upon execution by a computing device, cause the computing device to perform functions comprising receiving a plurality of data points corresponding a specific high grade instrument; the computing device embedded in a high grade instrument wherein said at least one computing device is communicatively coupled to at least one apparatus, the computing device determines one or more subset of data points indicative of the identity of said specific high grade instrument; based on an output of a comparison of the one or more predefined identification data with the subset of data points, execute in a sequence specific to the high grade instrument, one or more applications associated with the high grade instrument, to propagate signaling information towards the at least one apparatus, thereby enabling said at least one apparatus to interact with the at least one computing device and exchange a plurality of data points with the at least one computing device for use in updating the one or more corresponding applications, wherein the operation of the high grade instrument is remotely enabled and its configuration locally controlled.

A further embodiment provides a non-transitory computer readable medium having stored thereon instructions that, upon execution by an apparatus, cause the apparatus to perform functions comprising compiling one or more databases associated with a plurality of high grade instruments, propagating configuration data towards the at least one computing device, thereby enabling said at least one computing device to interact with the apparatus and exchange a plurality of data points with the apparatus for use in updating the one or more corresponding databases, wherein the operation of the high grade instrument is remotely enabled and its configuration locally controlled.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a system benefiting from embodiments of the present invention;

FIG. 2 depicts an exemplary computing device suitable for use in the system depicted in FIG. 1; and

FIG. 3 depicts a state machine for one embodiment of a method for a secure weapon.

To facilitate understanding, identical reference numerals have been used to designate elements having substantially the same or similar structure and/or substantially the same or similar function.

### DETAILED DESCRIPTION OF THE INVENTION

Various embodiments provide a system and method for providing a cyber and physically secure high grade weaponry.

The illustrative system and method embodiments described herein are not meant to be limiting. It may be readily understood that certain aspects of the disclosed system and methods can be arranged and combined in a variety of different configurations, all of which are contemplated herein.

One hears lamentations that U.S. weaponry used in theater often ends-up in the hands of inimical agents. Also, the U.S. taxpayers resent having to waste their tax money purchasing these weapons, which end up in the wrong hands in working order. Additionally, in some instances, “blood and (more) treasure” may be spent to go fight these inimical agents to defeat their weapons-facilitated nefarious goals. This invention squarely addresses this chronic and extant issue by embedding its cyber-logic into all manufactured high-grade weaponry then requiring a constant keep-alive signal from a satellite or other terrestrial broadcasting system in order for the weapon to remain operative. This cyber-logic in embedded in a tamper-proof micro-enclosure, which, if interfered with in any way, will permanently incapacitate the weapon.

It is astounding that satellite-based (or other media-based) Conditional Access Systems (CAS) are commonly used for TV/video, satellite radio, and other consumer applications (e.g., stolen car incapacitation, no-loan-payment car incapacitation), and yet are not applied to injury-causing weapons. It is astounding that even low-end weapons (rifles, shotguns, pistols) are obligatorily mandated by U.S., Law to have a serial number, while highly-destructive high-end weapons lack any usage control and dis-enabling/disabling means. It is perhaps tautological that there is a need for an invention that facilitates the dis-enabling of high-end weaponry. This novel and ostensively non-obvious invention provides a system and methods to disable weaponry in the theater, especially when these weapons are sold to partners-de-jour, who have later gone rogue. This invention, called here Military Grade Weapon Managing Conditional Usage System (MGWMC), should be mandated by U.S. as being applicable to all high-grade weaponry manufactured on or after a specified calendar date. The MGWMC disclosed herein can operate as a 1-way system (receive only, known here as r-MGWMC) or as a 2-way system (receive and transmit, known here as tr-MGWMC).

The high-end weapon deployed in the field with the invention of the MGWMC will require a robust/encrypted keep-alive signal to remain operational (should such signal not be received, the equipment will stop operation after T hours.) The keep-alive signal will be a well-defined encrypted stream, possibly including a 2-way handshake (in the tr-MGWMC embodiment). The electronics are included in a tamper-proof enclosure; the MGWMC is constructed such that any tampering will incapacitate the weapon. This invention does require that weaponry be re-architected in such a manner that the MGWMC is able to incapacitate the device that hosts it. High-end weapons, such as for example a tank, a helicopter, or a jet easily depend on on-board software-based mechanisms, hence, the addition of a MGWMC is fairly simple. Other weaponry will need to be redesigned to make them software/microprocessor dependent for proper operation, thus enabling the incorporation of this invention. Thus, the (future) development of software-driven weaponry is ideally suited for the incorporation of MGWMC controls disclosed in this invention.

The r-MGWMC comprises a tamper-proof enclosure; a receive antenna; an RF processing submodule; a Conditional Usage System submodule; a temporary Weapon Disabling submodule; a Weapons Malfunction submodule; a permanent Weapon Disabling submodule. The tr-MGWMC adds a transmit antenna (with transmitter), and possibly a GPS submodule.

The tamper-proof enclosure is expected to be small (e.g., 3×3 cm or 4×4 cm, or as needed), and can contain, if/as needed, explosive charges to physically incapacitate its content as well as other critical weapon-operating components, thus rendering the weapon inoperative.

The (omini) antenna will be able to receive satellite signals in the L-, C-, X-, ku- and ka-bands (and other) as well as terrestrial cellular/WiMax frequencies. For satellite reception, the L-band and the Ku/ka bands are likely more easily supported (especially by smaller weapons—a tank or personnel carrier could perhaps support C-band, since the C-band antenna would typically be larger.)

The RF processing submodule should be able to decode spread spectrum signals and advanced modulation/Forward Error Correction (FEC) content.

The military-grade Conditional Usage System (CUS) submodule is a high-end logically ruggedized system that includes functionality similar to a commercial Conditional Access System, but with added system reliability, security, and functionality. As a minimum it will include encryption capabilities of 2048, 4096, or 8192-bit encryption. In addition it will be able to “unpack” messages (e.g., IP packets) to ascertain that the parameters included in the received message conform to an established protocol for the keep-alive signal. The CUS will keep track of the received keep-alive signal (to establish it conform to an established protocol) and the time horizon of received said signals. If the time to receive the next signal is exceeded, the module will instruct the temporary Weapon Disabling submodule to initiate a disabling function. The CUS is the overall manager keeping track of the system state machine. At some point later (or upon receiving—in some fashion—a coded message) the CUS may proceed to activate the Weapons Malfunction submodule or the permanent Weapon Disabling submodule.

The temporary Weapon Disabling submodule disables the operation of the weapon for an established (or CUS-provided) time frame. It will retain this state until instructed otherwise by the CUS; however the process is reversible.

The Weapons Malfunction submodule causes the weapon to malfunction, either in performing in a highly suboptimal fashion, or even causing point-of-activation damage around a defined radius of reach. A software virus may be one non-limiting example. The permanent Weapon Disabling submodule disables the operation of the weapon in a permanent fashion; this could include a software crash or even a (kinetic) hardware crash. A software virus may be one non-limiting example.

The long-duration battery keeps the system going. If the battery is removed, the weapon system will become completely non-operational (this state is in addition to the impact of tampering with the enclosure and serves as a second point of incapacitation. When the battery reaches a certain discharge threshold, the system will enter an end-state disabling mode (by invoking the services of the permanent Weapon Disabling submodule.)

The MGWMC could include actuators that support some of the incapacitation functions discussed above; otherwise the incapacitation may be based on corrupting/destroying the software that a high grade depends on for proper functioning. The keep-alive signal is distributed via satellite from a control center using any available technology such as LEO, MEO, GEO, HTS, or military satellite, In some cases terrestrial distribution either over cellular/WiMax or other transmission channels, may be used to distribute the keep-alive signal.

The fact that radio waves may not penetrate highly-fortified (reinforced cement, cave-based, or bunker-based) structures works to the advantage of this invention in the sense that if an inimical agent seeks to abscond and hide the weaponry in some subterraneous location, the weapon will be disabled.

As noted, the tr-MGWMC adds a transmit antenna (with transmitter), and a possibly a GPS submodule. Upon receiving a defined message from the control center, the MGWMC may be able (but not in all cases) to broadcast its location to the control center. An inimical agent's attempt to shield the weapon from receiving the GPS signal will likely also shield it from receiving the keep-alive signal, thus effectively creating a self-defeating circumstance. In some cases, if the GPS system is not working, the tr-MGWMC may possibly be able to transmit back the spot-beam ID where it received the signal (assuming that the transmitting satellite is spot-beam-based), thus at least giving a general location where the “misplaced” weapon might be.

Software-based weapon are in theory subject to unfriendly cyberattacks. Thus the MGWMC needs to implement strong mechanisms for intrusion prevention. The use of (a) high-end encryption, (b) the establishment of an agreed-up control syntax, and (c) the requirement that the received signal is only injectable via a spread-spectrum-based ‘air interface’ will protect the legitimate use of the weapon. Also, while in friendly hands, a bypass mechanism may be optionally be implemented (for example with a mechanical but detachable mechanical key). In the latter case, a jamming signal from an inimical agent to attempt to block the keep-alive signal will prove non-effective. Another option is to include MGWMC capabilities only on weapons given/sold to non-U.S. parties.

This invention squarely addresses this chronic and extant issue by embedding its cyber-logic into all manufactured high-grade weaponry then requiring a constant keep-alive signal from a satellite or other terrestrial broadcasting system in order for the weapon to remain operative. This cyber-logic in embedded in a tamper-proof micro-enclosure, which if interfered with in any way will permanently incapacitate the weapon.

Generally speaking, the various embodiments support receiving, processing and executing in a sequence specific to the specific high grade instrument, one or more applications associated with the high grade instrument. A computing device receives a plurality of data points corresponding to a specific high grade instrument, the computing device determines one or more subset of data points indicative of the identity of the high grade instrument to thereby support one or more concurrent applications resident on the high grade instrument. Additionally, digital technology is used to facilitate communications between the high grade instrument and a command center for example.

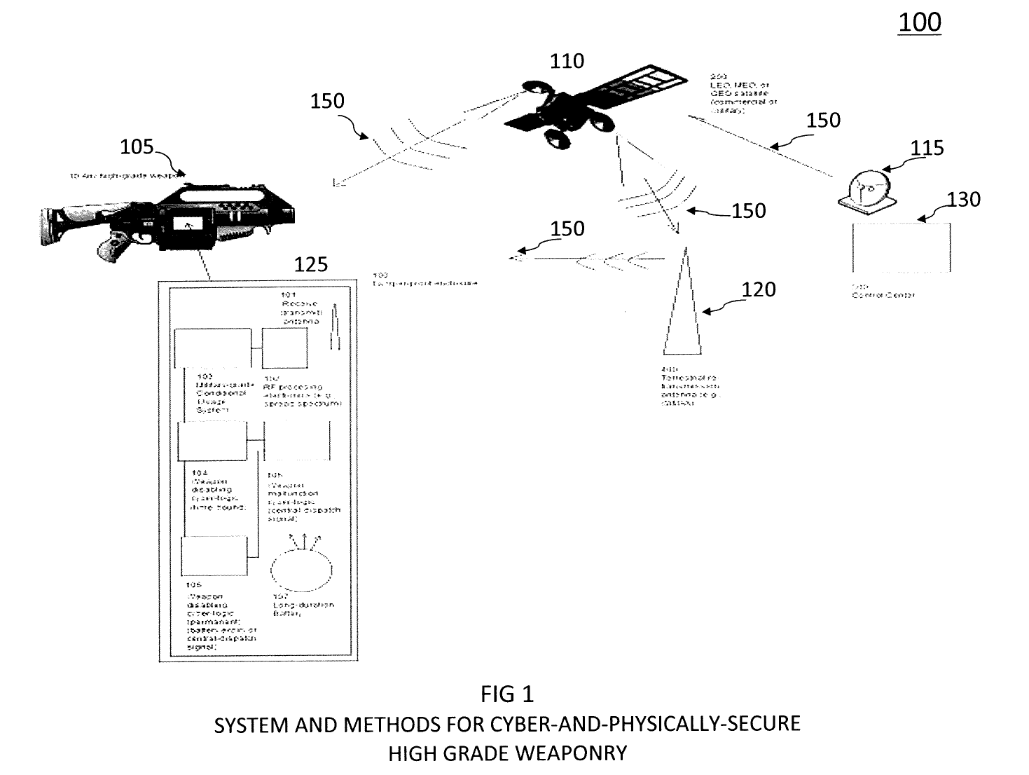

FIG. 1 depicts an exemplary cyber-and-physically secure system and methods according to an embodiment of the present invention. Generally speaking, any computing device communicating with a remotely located apparatus or command center may be configured to receive a plurality of data points corresponding to a specific high grade instrument. From the plurality of data points, the remotely located apparatus can then authenticate the user.

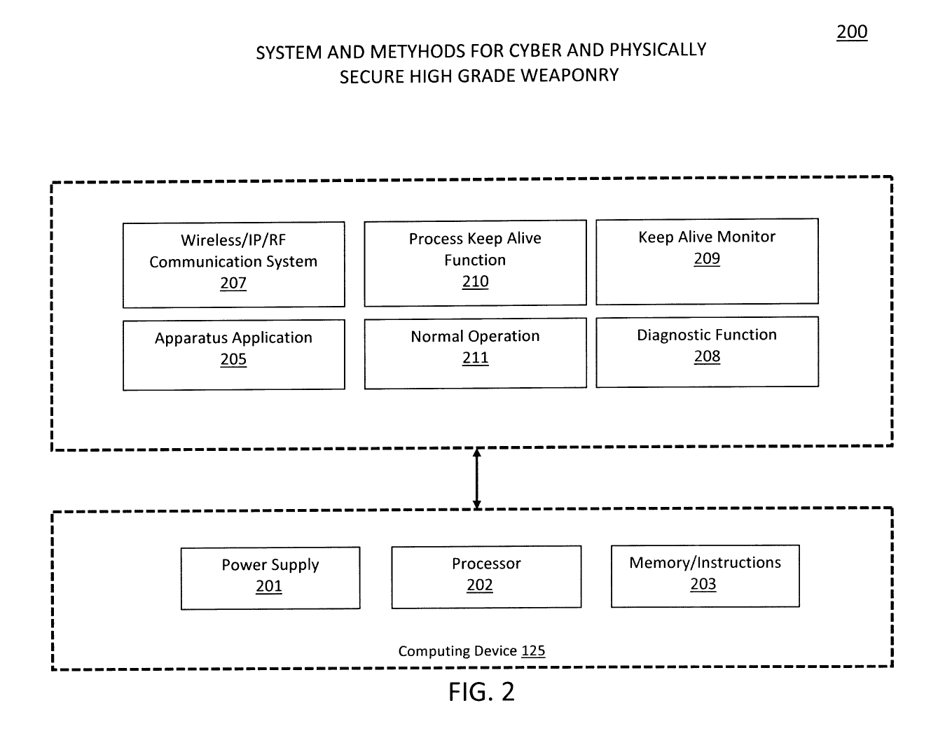

In one embodiment, high grade device or instrument 105 incorporates computing device 125, which is implemented using a computer such as depicted in FIG. 2. Generally speaking, any Internet enabled device such as personal digital assistant (FDA), laptop, desktop, electronic book, tablets and the like capable of accessing the Internet may implement the various embodiments described herein. While processors are generally discussed within the context of the description, the use of any device having similar functionality is considered to be within the scope of the present embodiments . Computing device 125 generally includes a central processing unit (CPU) connected by a bus to memory and storage (not shown). Each user interface device 125 is typically running an operating system configured to manage interaction between the different modules, submodules and associated applications, applications interfaces (APIs) and the like as known to an artisan of ordinary skill in the art.

In another embodiment, high grade device or instrument 105 includes tamper-proof enclosure; a receive antenna; high grade device or instrument 105 incorporates computing device 125, which comprises an RF processing submodule and one or more associated applications, a Conditional Usage System submodule and one or more associated applications, a temporary Weapon Disabling submodule and one or more associated applications, a Weapons Malfunction submodule and one or more associated applications; a permanent Weapon Disabling submodule and one or more associated applications. The RF processing submodule should be able to decode spread spectrum signals and advanced modulation/Forward Error Correction (FEC) content. The military-grade Conditional Usage System (CUS) submodule is a high-end logically ruggedized system that includes functionality similar to a commercial Conditional Access System, but with added system reliability, security, and functionality. As a minimum it will include encryption capabilities of 2048, 4096, or 8192-bit encryption. In addition it will be able to “unpack” messages (e.g., IP packets) to ascertain that the parameters included in the received message conform to an established protocol for the keep-alive signal. The CUS will keep track of the received keep-alive signal (to establish it conform to an established protocol) and the time horizon of received said signals. If the time to receive the next signal is exceeded, the module will instruct the temporary Weapon Disabling submodule to initiate a disabling function. The CUS is the overall manager keeping track of the system state machine. At some point later (or upon receiving—in some fashion—a coded message) the CUS may proceed to activate the Weapons Malfunction submodule or the permanent Weapon Disabling submodule, The temporary Weapon Disabling submodule disables the operation of the weapon for an established (or CUS-provided) time frame. It will retain this state until instructed otherwise by the CUS; however the process is reversible. The Weapons Malfunction submodule causes the weapon to malfunction, either in performing in a highly suboptimal fashion, or even causing point-of-activation damage around a defined radius of reach. A software virus may be one non-limiting example. The permanent Weapon Disabling submodule disables the operation of the weapon in a permanent fashion; this could include a software crash or even a (kinetic) hardware crash. A software virus may be one non-limiting example.

In yet another embodiment, computing device 125 further includes a transmit antenna (with transmitter), and a GPS submodule and one or more associated applications. The GPS submodule interacts with Satellite 110, which is generally a geo-synchronous satellite system such as global positioning system (GPS). In one embodiment, satellite 110 is low earth orbit satellite system. In other embodiments, the use of any system having similar functionality is considered to be within the scope of the present embodiments. The (omini) antenna is able to receive satellite signals in the L-, C-, X-, ku- and ka-bands (and other) as well as terrestrial cellular/WiMax frequencies. For satellite reception, the L-band and the Ku/ka bands are likely more easily supported (especially by smaller weapons—a tank or personnel carrier could perhaps support C-band, since the C-band antenna would typically be larger.)

In one embodiment, computing device 125 interacts with GPS based networks 110, 115 and Cellular based network 120 via link 150. In one embodiment, link 150 extends over great distance and is a cable, satellite or fiber optic link, a combination of such links or any other suitable communications path. In other embodiments, link 150 extends over a short distance. In other embodiments, link 150 may be a local area network where both computing device 125 and apparatus 130 reside in the same general location, or may be network connections between geographically distributed systems, including network connection over the Internet. In other embodiments, link 150 is wireless. Yet, in other embodiments link 150 may be an access network, a virtual private network. In other embodiments, link 150 is any communication network, the Internet, the Cloud and other networks having similar functionality and is therefore considered to be within the scope of the present embodiments.

Command Center or apparatus 130 includes any system used as part of corporate management obtaining user input and gathering input from other systems to thereby provide responsive output. Generally, apparatus 130 deal with databases and data processing components. Apparatus 130 typically implements responses to computing device 125 queries, commands and the like.

Cellular system 120 is generally a wireless infrastructure supporting cellular network functionality. In one embodiment, cellular system 120 is a small area wireless system. In other embodiments, cellular system 120 is a wide area wireless system. In other embodiments, cellular system 120 is a Wi-Fi system. In other embodiments, the use of any wireless system having similar functionality is considered to be within the scope of the present embodiments .

FIG. 2 depicts an exemplary high-level block diagram of computing device 125 suitable for use in the system of FIG. 1. It will be appreciated that the architecture of computing device 125 may be divided in any other suitable division for providing the services associated with system 100.

Computing device 125 may include power supplies 201, a processor 202, a memory 203 for storing instructions and the like. Power supply 201 provides power to computing device 125. As such, the power supply may include, for example backup batteries. Other power supply configurations are possible as well. The long-duration battery keeps the system going. If the battery is removed the weapon system will become completely non-operational (this state is in addition to the impact of tampering with the enclosure and serves as a second point of incapacitation). When the battery reaches a certain discharge threshold, the system will enter an end-state disabling mode (by invoking the services of the permanent Weapon Disabling submodule.)

Processor 202 included in computing device 125 may comprise one or more general-purpose processors and/or one or more special-purpose processors (e.g., image processor, digital signal processor, vector processor, etc.). To the extent that computing device 125 includes more than one processor, such processors could work separately or in combination. Computing device 125 may be configured to control functions of system 100 based on input received from apparatus or command center 130 via wireless/IP/RF communication system API 207, for example.

Memory 203 may comprise one or more volatile and/or nonvolatile storage components such as optical, magnetic, and/or organic storage and memory 203 may be integrated in whole or in part with computing device 125.

Memory 203 may contain instructions (e.g., applications programming interface (API), configuration data) executed by processor 202 in performing various functions of system 100, including any of the functions or methods described herein. Memory 203 may further include instructions executable by processor 202 to control and/or communicate with the additional components of high grade instrument 105. These APIs are also used in various embodiments for transferring data from Apparatus Application 205 to Normal Operation 211. Although depicted and described with respect to the aforementioned APIs, it will be appreciated by those skilled in the art that other APIs having similar functionality are considered to be within the scope of the present embodiments.

Computing device 125 may include one or more elements in addition to or instead of those shown.

System 100 is developed mainly on two platforms namely, Apparatus Application 205 and Normal Operation 211. Apparatus application 205 is developed using JAVA, Eclipse as SDK (Software Development Kit), PHP language and MySQL as data base. Languages equivalent to JAVA and Eclipse, PHP and MySQL may be used to build Apparatus application 205 and Normal Operation 211. Various APIs included in Memory 203 are used for the various functions (described in greater details infra) of system 100. For example, (Representational State Transfer) REST API, Wireless/IP Communication System API (HTTP) are mainly used for web services. REST APIs are also used to connect database on apparatus 130 with Apparatus application 205.

In one embodiment, Start time, coded message, signaling information or location identifier are passed by the plurality of APIs from Apparatus application 205 to Normal Operation 211.

Although depicted and described with respect to an embodiment in which each of the APIs, engines, databases, and tools is stored within memory 203, it will be appreciated by those skilled in the art that the APIs, engines, database, and/or tools may be stored in one or more other storage devices internal to computing device 125 and/or external to computing device 125, The APIs, engines, databases, and/or tools may be distributed across any suitable numbers and/or types of storage devices internal and/or external to computing device 125.

The APIs, engines and tools may be activated in any suitable manner. In one embodiment, for example, the APIs, engines and tools may be activated in response to manual requests initiated by a user, in response to automated requests initiated by computing device 125, or other devices and the like, as well as various combinations thereof.

For example, where an engine or tool is activated automatically, the engine or tool may be activated in response to scheduled requests, in response to requests initiated by computing device 125 based on processing performed at computing device 125 or apparatus 130.

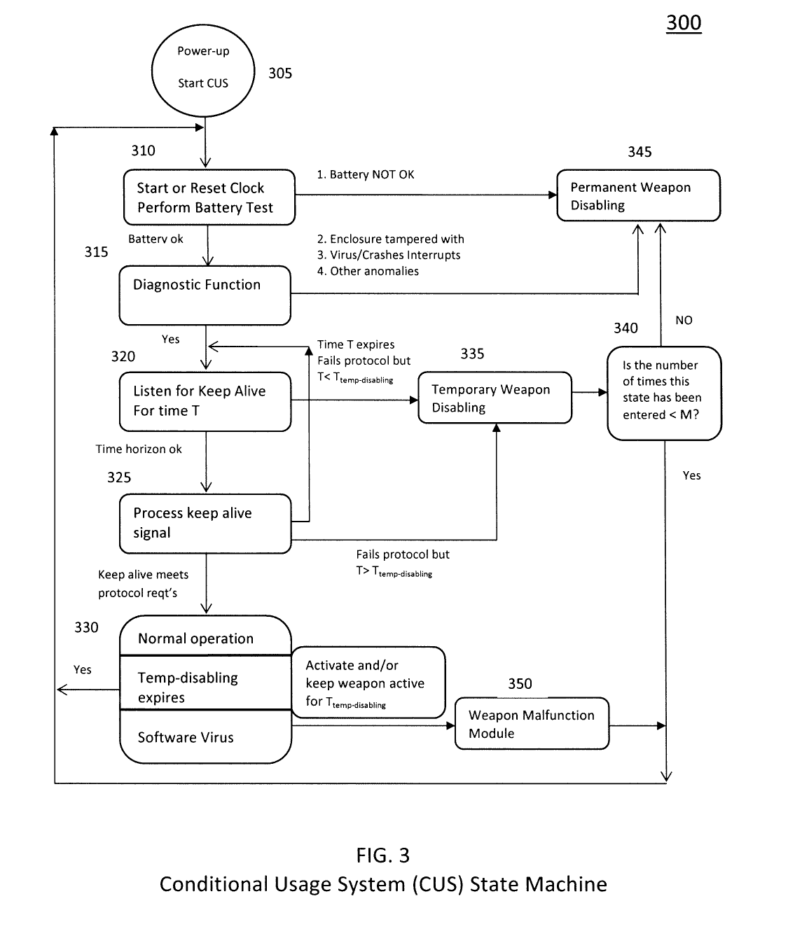

In one embodiment, Apparatus 130 may be a smart device, which is configured to provide computing device 105 with signaling information linking the apparatus to the computing device. In some embodiment, signaling information propagated towards computing device 105 comprises a link, a compounded link and the like. In other embodiments, signaling information propagated towards apparatus 105 comprises discrete data or series of data points orchestrated in a synchronous manner. In yet other embodiments, the signaling information expires after a set time or cascaded expiration time. FIG. 3 depicts one embodiment of a method for a remotely controlled equipment. Specifically, FIG, 3 depicts a state machine of a method 300 adapted for use in implementing the functions of system 100. Software-based weapons are in theory subject to unfriendly cyberattacks. Thus, the MGWMC needs to implement strong mechanisms for intrusion prevention. The use of (a) high-end encryption, (b) the establishment of an agreed-up control syntax, and (c) the requirement that the received signal is only injectable via a spread-spectrum-based ‘air interface’ will protect the legitimate use of the weapon. Also, while in friendly hands, a bypass mechanism may optionally be implemented (for example with a mechanical but detachable mechanical key). In the latter case, a jamming signal from an inimical agent to attempt to block the keep-alive signal will prove non-effective. Another option is to include MGWMC capabilities only on weapons given/sold to non-U.S. parties.

Various embodiments operate to provide a flexible high grade instrument that can be tuned to achieve some of the above outlined objectives without sacrificing others. For example, in one embodiment the equipment is controlled and managed by a keep-alive signal. Should the high grade device disclosed herewith be tampered with, or lose its keep-alive signal (say from a satellite), or the intrinsic battery discharge, the weapon is temporarily or permanently incapacitated. In another embodiment, the weapon self-destroys.

At step 305, the user of the high grade device turns the device on. Referring to box 310, computing device 125 clock starts or resets if already running. Consequently, computing device 125 executes diagnostic function 208. Diagnostic function 208 includes the following tests namely,

(1) Battery Test. If the battery reaches a certain discharge threshold, the system will enter an end-state disabling mode (by invoking the services of the permanent Weapon Disabling submodule—345). If the battery is ok step 315 is executed where the remainder of the diagnostic tests are performed;

(2) Enclosure Test If the tamper-proof enclosure is interfered with in any way, the weapon is permanently incapacitated (by invoking the services of the permanent Weapon Disabling submodule—345). The tamper-proof enclosure is expected to be small (e.g., 3×3 cm or 4×4 cm, or as needed), and can contain, if/as needed, explosive charges to physically incapacitate its content as well as other critical weapon-operating components, thus rendering the weapon inoperative;

(3) Virus/Crashes Interrupts. The operation of the weapon is disabled in a permanent fashion; this could include a software crash or even a (kinetic) hardware crash. A software virus may be one non-limiting example.

(4) Miscellaneous Tests. This category includes proper functioning of subcomponents function including the clock, cyber security infractions including code modification, crashes and any other system interrupts and newly developed tests. Although depicted and described with respect to the category of diagnostic tests herein listed, it will be appreciated by those skilled in the art that the list is not limiting.

At step 320, the keep-alive signal is monitored by invoking the services of the Keep-Alive Monitor 209. The keep-alive signal distributed (207, 110, 115, 150) via satellite from a control center using any available technology such as LEO, MEO, GEO, HTS, or military satellite, is monitored. In some embodiments, terrestrial distribution either over cellular/WiMax (by invoking the services of 207) or other transmission channels, may be used to distribute the keep-alive signal. The high-end weapon deployed in the field with the invention of the MGWMC will require a robust/encrypted keep-alive signal to remain operational (should such signal not be received, the equipment will stop being operation after T hours.) The keep-alive signal is a well-defined encrypted stream, possibly including a 2-way handshake (in the tr-MGWMC embodiment), Time “T” is provided by the apparatus or control center. Referring to step 320, Tₖₑₑₚ₋ₐₗᵢᵥₑ is the time interval at which the keep-alive messages are received such that Tₖₑₑₚ₋ₐₗᵢᵥₑ<T_{temp-disabling} and T_{keep- alive}=factor×T_{temp-disabling}. In one embodiment, factor=0.1. In other embodiments, factor is greater than 0.1. The factor can be adjusted based on the device and other parameters such as location, age of the high grade device and the like.

At step 325, the keep-alive signal is processed by invoking the services of the Process Keep-Alive Function 210. The received spread-spectrum keep-alive signal is decoded (by invoking the services of 207) and error control (e.g., Forward Error Correction, FEC) is performed. The keep-alive signal is further decrypted to (1) establish that the received sequence conforms to the keep-alive syntax; (2) determine if other control center commands are embedded within the signaling information; (3) keep time-horizon for legitimate keep-alive signals received; and (4) establish if the temporary weapon disabling module (step 335) or the permanent weapon disabling module (step 345) or the weapon malfunction module (step 350) needs to be invoked, In one embodiment, upon request from the control center the GPS location is transmitted back to control center. Step 320 is executed if time “T” expires or there is a protocol failure and T<T_{temp-disabling}. Referring to step 325 in one embodiment, T_{temp-disabling} is the maximum amount of time CUS operates without a fresh keep alive signal before entering a “temporary disabled” state. In one embodiment, this T_{temp-disabling} is one (1) minute. In other embodiments, the time is less than one (1) minute. In yet other embodiments, the time is greater than one (1) minute. Referring to step 325 in one embodiment, step 320 is executed as discussed above. In another embodiment, step 335 is executed if there is a protocol failure and T>T_{temp-disabling}. At step 335, a variable M denoting the maximum times the “temporary disabling” state can be invoked is tested. In one embodiment, M is set to 5. In other embodiments, M is set greater than 5, for example 8 or 10. If the test for M is true, then step 310 is executed. In another embodiment, if the test for M is false then step 335 is executed.

At step 330, in one embodiment the device enters normal operation (activated). In this state, a software virus would cause step 350 to be invoked. The Weapons Malfunction submodule causes the weapon to malfunction, either in performing in a highly suboptimal fashion, or even causing point-of-activation damage around a defined radius of reach. In another embodiment the device enters active state for T_{temp-disabling}. In this state, when T_{temp-disabling} expires step 310 is invoked. Although primarily depicted and described herein with respect to the above-mentioned embodiments, it will be appreciated that the algorithm may be used in other embodiments.

Although various embodiments which incorporate the teachings of the present invention have been shown and described in detail herein, those skilled in the art can readily devise many other varied embodiments that still incorporate these teachings.

1. A system comprising:
at least one computing device embedded in a high grade instrument wherein said at least one computing device is communicatively coupled to at least one apparatus;
a memory arrangement having stored thereon instructions that upon execution by the at least one computing device, cause the at least one computing device to execute in a sequence specific to the high grade instrument, one or more applications associated with the high grade instrument, to propagate signaling information towards the at least one apparatus, thereby enabling said at least one apparatus to interact with the at least one computing device and exchange a plurality of data points with the at least one computing device for use in updating the one or more corresponding applications,
wherein the operation of the high grade instrument is remotely enabled and its configuration locally controlled.

2. The system of claim 1, wherein the at least one computing device includes a processor.

3. The system of claim 1, wherein the at least one apparatus includes a smart device, a web site, a robot.

4. The system of claim 1, wherein the at least one apparatus further includes a desk top computer, a super-computer, a laptop.

5. The system of claim 1, wherein the at least one apparatus further includes a local area network (LAN), a virtual private network (NTN), a wide area network (WAN), a WiFi Access Point, a Global Positioning Satellite (GPS).

6. The system of claim 1, wherein the high grade instrument is a weapon.

7. The system of claim 1, wherein the one or more applications include self-executing applications and application programming interface (API).

8. The system of claim 1, wherein the one or more data points include a keep alive signal.

9. The system of claim 1, wherein the signaling information include positioning data, location information.

10. The system of claim 1, wherein the one or more applications are updated by the at least one apparatus, said applications being updated synchronously, randomly, on a scheduled basis, in real time or on demand.

11. The system of claim 1, wherein signaling information is updated randomly, on a scheduled basis, in real time or on demand.

12. The system of claim 1, wherein the to the high grade instrument specific sequencing includes executing

13. A method comprising:
a computing device receiving a plurality of data points corresponding to a specific high grade instrument;
the computing device embedded in a high grade instrument wherein said at least one computing device is communicatively coupled to at least one apparatus, the computing device determines one or more subset of data points indicative of the identity of said specific high grade instrument;
based on an output of a comparison of the one or more predefined identification data with the subset of data points, execute in a sequence specific to the high grade instrument, one or more applications associated with the high grade instrument, to propagate signaling information towards the at least one apparatus, thereby enabling said at least one apparatus to interact with the at least one computing device and exchange a plurality of data points with the at least one computing device for use in updating the one or more corresponding applications,
wherein the operation of the high grade instrument is remotely enabled and its configuration locally controlled.

14. (Original The method of claim 13, wherein the high grade instrument is a weapon.

15. The method of claim 14, wherein the at least one apparatus includes a smart device, a web site, a robot.

16. A non-transitory computer readable medium having stored thereon instructions that, upon execution by a computing device, cause the computing device to perform functions comprising:
receiving a plurality of data points corresponding a specific high grade instrument;
the computing device embedded in a high grade instrument wherein said at least one computing device is communicatively coupled to at least one apparatus, the computing device determines one or more subset of data points indicative of the identity of said specific high grade instrument;
based on an output of a comparison of the one or more predefined identification data with the subset of data points, execute in a sequence specific to the high grade instrument, one or more applications associated with the high grade instrument, to propagate signaling information towards the at least one apparatus, thereby enabling said at least one apparatus to interact with the at least one computing device and exchange a plurality of data points with the at least one computing device for use in updating the one or more corresponding applications,
wherein the operation of the high grade instrument is remotely enabled and its configuration locally controlled.

17. The non-transitory computer readable medium of claim 17, wherein the computing device is a processor.

18. The non-transitory computer readable medium of claim 17, wherein the at least one apparatus includes a smart device, a web site, a robot.

19. The non-transitory computer readable medium of claim 16, further comprising:
compiling one or more databases associated with a plurality of high grade instruments, propagating configuration data towards the at least one computing device, thereby enabling said at least one computing device to interact with the apparatus and exchange a plurality of data points with the apparatus for use in updating the one or more corresponding databases,
wherein the operation of the high grade instrument is remotely enabled and its configuration locally controlled.

20. (canceled)
